(19) United States
(12) Patent Application Publication
(10) Pub. No.: US 2023/0093142 A1
(43) Pub. Date: Mar. 23, 2023

(54) METHOD AND SYSTEM FOR BUILDING THERMAL MODEL OF POWER LITHIUM-ION BATTERY BASED ON ELECTROCHEMICAL MECHANISM

(71) Applicant: Shanghai Jiao Tong University, Shanghai (CN)

(72) Inventors: Bangjun Guo, Shanghai (CN); Xi Zhang, Shanghai (CN); Chong Zhu, Shanghai (CN)

(21) Appl. No.: 18/072,075

(22) Filed: Nov. 30, 2022

Related U.S. Application Data
(63) Continuation-in-part of application No. PCT/CN2022/094858, filed on May 25, 2022.

(30) Foreign Application Priority Data
Jun. 1, 2021 (CN) 202110608603.X

(51) Int. Cl. G06F 30/23; G06F 17/11

(52) U.S. Cl. CPC G06F 30/23; G06F 17/11; G06F 2119/08

(57) ABSTRACT

A method and system for building a thermal model of a power lithium-ion battery based on an electrochemical mechanism. The method includes: discretizing a second order partial differential heat conduction equation of a power lithium-ion battery according to a finite differential method, thereby building a thermal model of the power lithium-ion battery; carrying out a dynamic working condition test by using a cylindrical power lithium-ion battery selected as an object, thereby acquiring experimental data such as a temperature, a current, a voltage, and a temperature of a surface of the battery; identifying an electrochemical parameter of the power lithium-ion battery according to an optimal parameter algorithm by using test data acquired in a dynamic working condition, thereby building a thermal model of the power lithium-ion battery; and verifying accuracy of the thermal model of the power lithium-ion battery by using test data acquired in another dynamic working condition.

### CROSS REFERENCE TO RELATED APPLICATION

The present patent application is a continuation-in-part of PCT/CN2022/094858 filed on May 25, 2022, the disclosure of which is incorporated herein by reference in its entirety, and claims the benefit and priority of Chinese Patent Application No. 202110608603.X filed with National Intellectual Property Administration, PRC on Jun. 1, 2021 and entitled “METHOD AND SYSTEM FOR BUILDING THERMAL MODEL OF POWER LITHIUM-ION BATTERY BASED ON ELECTROCHEMICAL MECHANISM”, which is incorporated herein by reference in its entirety.

### TECHNICAL FIELD

The present disclosure relates to the field of management technologies for lithium-ion batteries of electric vehicles, and in particular, to a method and system for building a thermal model of a power lithium-ion battery based on an electrochemical mechanism.

### BACKGROUND ART

With an increasingly higher requirement for an energy density of a lithium-ion battery in the market of electric vehicles, a problem in thermal safety of lithium batteries is exposed. In a use process, a temperature of a battery may be too high, or even a thermal runaway phenomenon may occur, which leads to phenomena such as smoking, firing, and even explosion. Therefore, it is crucial to build a thermal model by which a temperature distribution of a battery can be monitored accurately.

Chinese Patent Application whose publication number is CN109141685A discloses a method and an apparatus for calculating a heat generation rate of a battery. The method includes: 101: in a discharging process of a battery, measuring and recording a working voltage U(t), an open-circuit voltage E(t), and a current I(t) of the battery in real time, where t denotes a current discharging moment, 0≤t≤T, and T denotes total discharging duration; 102: calculating an internal discharging resistance R(t) of the battery at each measured discharging moment based on a working voltage U(t) and a current I(t) of the battery that are measured in real time, and calculating a temperature coefficient e(t) of an open-circuit voltage of the battery at each measured discharging moment based on an open-circuit voltage E(t) that is of the battery and measured in real time, and 103: calculating a heat production rate q(t) of the battery based on the internal discharging resistance R(t) and the temperature coefficient e(t) of the open-circuit voltage of the battery.

At present, there are mainly the following two types of thermal models for lithium-ion batteries: thermal models based on internal mechanisms and thermal models based on equivalent circuits. A thermal model based on an internal mechanism can accurately simulate a heat generation law and an internal temperature distribution of a battery, but is too complex to be used in practice when an amount of calculation is too large. A thermal model based on an equivalent circuit is too simple to accurately acquire an internal temperature distribution of a battery.

### SUMMARY

Based on this, the present disclosure provides a method and system for building a thermal model of a power lithium-ion battery based on an electrochemical mechanism, to verify accuracy of a heat generation model of a battery by estimating a temperature of a surface of the battery, thereby improving reliability and safety of a battery pack.

To achieve the above objective, the present disclosure provides a method and system for building a thermal model of a power lithium-ion battery based on an electrochemical mechanism. The following solutions are used.

According to a first aspect, a method for building a thermal model of a power lithium-ion battery based on an electrochemical mechanism is provided. The method includes:

step S1: discretizing a second order partial differential heat conduction equation of a power lithium-ion battery according to a finite differential method, thereby building a thermal model of the power lithium-ion battery;

step S2: carrying out a dynamic working condition test by using a cylindrical power lithium-ion battery selected as an object, thereby acquiring experimental data such as a temperature, a current, a voltage, and a temperature of a surface of the battery;

step S3: identifying an electrochemical parameter of the power lithium-ion battery according to an optimal parameter algorithm by using test data acquired in a dynamic working condition, thereby building a thermal model of the power lithium-ion battery; and

step S4: verifying accuracy of the thermal model of the power lithium-ion battery by using test data acquired in another dynamic working condition.

Preferably, step S1 includes:

step S1.1: discretizing a second order partial differential import equation of a cylindrical power lithium-ion battery according to the finite differential method, thereby building a thermal model of a one-dimensional state space of the cylindrical power lithium-ion battery; and

step S1.2: determining an impact of a temperature on an electrochemical parameter of the battery according to an Arrhenius equation, thereby establishing a coupling relationship of the temperature to the electrochemical parameter of the battery.

Preferably, step S1.1 specifically includes:

step S1.1.1: assuming that a temperature distribution of the cylindrical power lithium-ion battery complies with the following one-dimensional unsteady-state heat conduction equation of cylindrical coordinates:

$$ρ c \frac{\partial T}{\partial t} = \frac{λ}{r} \frac{\partial T}{\partial r} + λ \frac{{\partial }^{2} T}{\partial {r}^{2}} + q ;$$

building a boundary condition:

$$\{ \begin{matrix}{- λ \frac{\partial T}{\partial r} \vert}_{{r}_{0}} = {h}_{0} ( {T}_{0} - {T}_{1} ) = 0 \\ {- λ \frac{\partial T}{\partial r} \vert}_{R} = h ( {T}_{R} - {T}_{amb} )\end{matrix} ;$$

building an initial condition: T(t)=T_{amb}; and

building a supplementary condition: T₁(t)≈T₀(t),

where T₀ denotes a temperature of a thin air layer that is of a hollow portion of the battery and that is closest to an inner-most layer of the battery; T₁ denotes a temperature of the inner-most layer of the battery; T_{R} denotes a temperature of a surface of the battery; h₀ denotes a convection-diffusion coefficient of the thin air layer; h denotes a convection-diffusion coefficient of the surface of the battery;

$$a = \frac{λ}{ρ c}$$

denotes a thermal diffusivity; ρ denotes a density of the power lithium-ion battery; c denotes a specific heat capacity J/(kg·° C.) of the power lithium-ion battery; and λ denotes a radial thermal conductivity;

step S1.1.2: respectively approximating a first-order partial differential equation and a second-order partial differential equation by using a backward difference method and a central difference method, thereby discretizing the second order partial differential heat conduction equation:

$$\frac{\partial T}{\partial r} \approx \frac{{T}_{k + 1} - {T}_{k - 1}}{2 Δ r} , \frac{{\partial }^{2} T}{\partial {r}^{2}} \approx \frac{{T}_{k + 1} - 2 {T}_{k} + {T}_{k - 1}}{{( Δ r )}^{2}} ;$$

step S1.1.3: representing the one-dimensional unsteady-state heat conduction equation of the cylindrical power lithium-ion battery as follows:

$${\dot{T}}_{k} = \frac{{a}_{k}}{{r}_{k}} \frac{{T}_{k + 1} - {T}_{k - 1}}{2 Δ r} + {a}_{k} \frac{{T}_{k + 1} - 2 {T}_{k} + {T}_{k - 1}}{{( Δ r )}^{2}} + \frac{{a}_{k}}{λ} q ( t ) , k = 1 , 2 , 3 … , M - 1 ,$$

where

$$Δ r = \frac{R - {r}_{0}}{M} ; {r}_{k} = {r}_{0} + k Δ r ;$$

M denotes a quantity of walls of the cylindrical power lithium-ion battery; and r_{M}=R; and

when

$${b}_{k} = \frac{{a}_{k}}{2 {r}_{k} Δ r} and {d}_{k} = \frac{2 {a}_{k}}{{( Δ r )}^{2}} ,$$

$${\dot{T}}_{k} = ( {b}_{k} + {d}_{k} ) {T}_{k + 1} - 2 {d}_{k} {T}_{k} + ( - {b}_{k} + {d}_{k} ) {T}_{k - 1} + \frac{{a}_{k}}{λ} q ( t ) ;$$

and

representing the temperature T_{M} of the surface of the battery as follows:

$${T}_{k = M} = \frac{{λ}_{M}}{h Δ {r}_{M} + {λ}_{M}} {T}_{k = M - 1} + \frac{h Δ {r}_{M}}{h Δ {r}_{M} + {λ}_{M}} {T}_{amb} ,$$

where q(t)=qₚ+qᵣ; the equation is solved in step S1.1.4; T_{M}=T_{R}; T_{M} denotes a temperature of an outer layer of the battery; λ_{M} denotes a thermal conductivity of an outer-layer material; and Δr_{M} denotes a thickness of the outer-layer material;

step S1.1.4: according to a polarization phenomenon and a current heating effect in charging and discharging processes of the battery, building the following calculation formula for a heat release rate of polarization heat and ohmic heat in a use process of the battery:

qₚ=I²R_{act}+I²Rₒₕₘ=I²Rₜ,

where I denotes a current of the battery; R_{act} denotes a polarization internal resistance of the battery; Rₒₕₘ denotes an ohmic internal resistance of the battery; Rₜ denotes a total internal resistance of the battery; and qₚ denotes a heat release rate of polarization heat and ohmic heat in a discharging process of the battery; and

combining calculation steps to acquire the following total heating power:

q=qᵣ+qₚ,

where q denotes a total heating power; qᵣ denotes a heat release rate of reaction heat of the battery; and qₚ denotes the heat release rate of the polarization heat and ohmic heat in the discharging process of the battery; and

step S1.1.5: determining a final model output according to an actual design demand for a system; carrying out approximation according to the finite differential method; iteratively updating an electrochemical parameter of the battery according to an Arrhenius equation; and calculating a system output temperature at a current moment;

defining a system state equation: \dot{x}=Ax+BU; and

defining a system output equation: y=Cx+Du,

where A and B denote system matrices; a system state is denoted by x=(T₁, T₂, . . . , T₁, . . . , T_{M-1})^{T}; a system input is denoted by q and is a heat generation rate per unit volume; and system output y denotes a temperature of an (M−1)^{th} layer of the battery.

Preferably, step S1.2 specifically includes: based on the relationship between a temperature and an electrochemical parameter of the battery, determining an impact of a temperature on a parameter of the battery according to the following Arrhenius equation:

$$ψ = {ψ}_{ref} exp [ \frac{{E}_{a}^{ψ}}{R} ( \frac{1}{{T}_{ref}} - \frac{1}{T} ) ] ,$$

ψ_{ref} is a general variable denoting a diffusion coefficient of a substance, an electrical conductivity of an electrolyte, an exchange current density of an electrode reaction electrode reaction, or the like; subscript ref denotes a value at a reference temperature; Eₐ^{ψ} denotes an activation energy; ψ denotes a diffusion coefficient; and T_{ref} denotes a reference temperature.

2 Preferably, in the step S1.1.5 each system matrix is denoted as follows:

$$A = ( - ( {b}_{1} + {d}_{1} ) , ( {b}_{1} + {d}_{1} ) , 0 , … , 0 ; - ( {b}_{2} + {d}_{2} ) , - 2 {d}_{2} , ( {b}_{2} + {d}_{2} ) , … , 0 : … ; 0 , 0 , 0 , … , - ( {b}_{M - 1} + {d}_{M - 1} ) , ( \frac{{λ}_{M - 1} ( {b}_{M - 1} + {d}_{M - 1} )}{h Δ r + {λ}_{M - 1}} - 2 {d}_{M - 1} ) ) ;$$

$$B ( i , 1 ) = {ρ}_{i} {c}_{i} ;$$

$$C = {( 0 , 0 , … , 0 , 1 )}^{T} ; and$$

$$D = 0 ,$$

where λ̅_̅{̅M̅-̅1̅}̅ denotes an axial thermal conductivity of an (M−1)^{th} laver; |B(i, 1) denotes a system matrix expression of an i^{th} layer; i denotes an expression of a layer number; ρᵢ denotes a density of a battery material of the i^{th} layer; cᵢ| denotes a battery specific heat capacity of the i^{th} layer; and a temperature denoted by system output y may be determined by adjusting a location of 1 in matrix C.

Preferably, step S2 includes:

step S2.1: selecting a power lithium-ion battery to be tested; and adhering thermocouples to the power lithium-ion battery according to a layout solution;

step S2.2: allowing the battery to stand still in a 25° C. incubator for 2 h:

step S2.3: charging the battery in a constant-current and constant-voltage manner to a fully charged state, namely, SOC=100%; discharging the battery at a speed of C/3 to SOC=95%; and allowing the battery to stand still for 2 h;

step S2.4: loading a dynamic working condition (Urban Dynamometer Driving Schedule, UDDS) to the battery by an appropriate proportion till state-of-charge (SOC) of the battery decreases to about 5%;

step S2.5: recording data such as a current, a voltage, an ambient temperature, and a surface temperature in the working condition;

step S2.6: repeating steps S2.2 to S2.5 at the same ambient temperature; and acquiring test data at the temperature in dynamic working conditions such as Federal Urban Driving Schedule (FUDS) and UDDS; and

step S2.7: changing the temperature of the incubator to 5° C., 10° C., and 35° C.; repeating steps S2.2 to S2.6; and acquiring test data at each of the temperatures in the dynamic working conditions.

Preferably, the optimal parameter algorithm in step S3 is a least square method.

According to a second aspect, a system for building a thermal model of a power lithium-ion battery based on an electrochemical mechanism is provided. The system includes:

a module M1 configured to: discretize a second order partial differential heat conduction equation of a power lithium-ion battery according to a finite differential method, thereby building a thermal model of the power lithium-ion battery;

a module M2 configured to: carry out a dynamic working condition test by using a cylindrical power lithium-ion battery selected as an object, thereby acquiring experimental data such as a temperature, a current, a voltage, and a temperature of a surface of the battery;

a module M3 configured to: identify an electrochemical parameter of the power lithium-ion battery according to an optimal parameter algorithm by using test data acquired in a dynamic working condition, thereby building a thermal model of the power lithium-ion battery; and

a module M4 configured to: verify accuracy of the thermal model of the power lithium-ion battery by using test data acquired in another dynamic working condition.

Preferably, the module M1 includes:

a module M1.1 configured to: discretize a second order partial differential import equation of a cylindrical power lithium-ion battery according to the finite differential method, thereby building a thermal model of a one-dimensional state space of the cylindrical power lithium-ion battery; and

a module M1.2 configured to: determine an impact of a temperature on an electrochemical parameter of the battery according to an Arrhenius equation, thereby establishing a coupling relationship of the temperature to the electrochemical parameter of the battery.

Preferably, the module M1.1 specifically includes:

a module M1.1.1 configured to: assume that a temperature distribution of the cylindrical power lithium-ion battery complies with the following one-dimensional unsteady-state heat conduction equation of cylindrical coordinates.

$$ρ c \frac{\partial T}{\partial t} = \frac{λ}{r} \frac{\partial T}{\partial r} + λ \frac{{\partial }^{2} T}{\partial {r}^{2}} + q ;$$

build a boundary condition:

$$\{ \begin{matrix}- λ \frac{\partial T}{\partial r} {\vert}_{{r}_{0}} = {h}_{0} ( {T}_{0} - {T}_{1} ) = 0 \\ - λ \frac{\partial T}{\partial r} {\vert}_{R} = h ( {T}_{R} - {T}_{amb} )\end{matrix} ;$$

build an initial condition: T(t)=T_{amb}; and

build a supplementary condition: T₁(t)≈T₀(t),

where T₀ denotes a temperature of a thin air layer that is of a hollow portion of the battery and that is closest to an inner-most layer of the battery; T₁ denotes a temperature of the inner-most layer of the battery; T_{R} denotes a temperature of a surface of the battery; h₀ denotes a convection-diffusion coefficient of the thin air layer; h denotes a convection-diffusion coefficient of the surface of the battery;

$$a = \frac{λ}{ρ c}$$

denotes a thermal diffusivity; ρ denotes a density of the power lithium-ion battery; c denotes a specific heat capacity J/(kg·° C.) of the power lithium-ion battery; and λ denotes a radial thermal conductivity;

a module M1.1.2 configured to: respectively approximate a first-order partial differential equation and a second-order partial differential equation by using a backward difference method and a central difference method, thereby discretizing the second order partial differential heat conduction equation:

$$\frac{\partial r}{\partial r} \approx \frac{{T}_{k + 1} - {T}_{k - 1}}{2 Δ r} , \frac{{\partial }^{2} r}{\partial {r}^{2}} \approx \frac{{T}_{k + 1} - 2 {T}_{k} + {T}_{k - 1}}{{( Δ r )}^{2}} ;$$

a module M1.1.3 configured to: represent the one-dimensional unsteady-state heat conduction equation of the cylindrical power lithium-ion battery as follows:

$${\dot{T}}_{k} = \frac{{a}_{k}}{{r}_{k}} \frac{{T}_{k + 1} - {T}_{k - 1}}{2 Δ r} + {a}_{k} \frac{{T}_{k + 1} - 2 {T}_{k} + {T}_{k - 1}}{{( Δ r )}^{2}} + \frac{{a}_{k}}{λ} q ( t ) , k = 1 , 2 , 3 ⋯ , M - 1 ;$$

where

$$Δ r = \frac{R - {r}_{0}}{M} ; {r}_{k} = {r}_{0} + k Δ r ;$$

M denotes a quantity of walls of the cylindrical power lithium-ion battery; and r_{M}=R; and

when

$${b}_{k} = \frac{{a}_{k}}{2 {r}_{k} Δ r} and {d}_{k} = \frac{2 {a}_{k}}{{( Δ r )}^{2}} ,$$

$${\dot{T}}_{k} = ( {b}_{k} + {d}_{k} ) {T}_{k + 1} - 2 {d}_{k} {T}_{k} + ( - {b}_{k} + {d}_{k} ) {T}_{k - 1} + \frac{{a}_{k}}{λ} q ( t ) ;$$

and

represent the temperature T_{M} of the surface of the battery as follows:

$${T}_{k = M} = \frac{{λ}_{M}}{h Δ {r}_{M} + {λ}_{M}} {T}_{k = M - 1} + \frac{h Δ {r}_{M}}{h Δ {r}_{M} + {λ}_{M}} {T}_{amb} ,$$

where q(t)=qₚ+qᵣ; the equation is solved by using module M1.1.4; T_{M}=T_{R}; T_{M} denotes a temperature of an outer layer of the battery; λ_{M} denotes a thermal conductivity of an outer-layer material; and Δr_{M} denotes a thickness of the outer-layer material;

a module M1.1.4 configured to: according to a polarization phenomenon and a current heating effect in charging and discharging processes of the battery, build the following calculation formula for a heat release rate of polarization heat and ohmic heat in a use process of the battery:

qₚ=I²R_{act}+I²Rₒₕₘ=I²Rₜ,

where I denotes a current of the battery; R_{act} denotes a polarization internal resistance of the battery; Rₒₕₘ denotes an ohmic internal resistance of the battery; Rₜ denotes a total internal resistance of the battery; and qₚ denotes a heat release rate of polarization heat and ohmic heat in a discharging process of the battery; and

combine calculation steps to acquire the following total heating power:

q=qᵣ+qₚ,

where q denotes a total heating power; qᵣ denotes a heat release rate of reaction heat of the battery; and qₚ denotes the heat release rate of the polarization heat and ohmic heat in the discharging process of the battery; and

a module M1.1.5 configured to: determine a final model output according to an actual design demand for a system; carry out approximation according to the finite differential method; iteratively update an electrochemical parameter of the battery according to an Arrhenius equation; and calculate a system output temperature at a current moment;

define a system state equation: \dot{x}=Ax+Bu; and

define a system output equation: y=Cx+Du,

where A and B denote system matrices; a system state is denoted by x=(T₁, T₂, . . . , Tᵢ, . . . , T_{M-1})^{T}; a system input is denoted by q and is a heat generation rate per unit volume; and system output y denotes a temperature of an (M−1)^{th} layer of the battery. According to the specific embodiments provided by the present disclosure, the present disclosure discloses the following technical effects:

1. A heat generation rate of a battery is acquired by analyzing an electrochemical mechanism of the battery; and accuracy of a heat generation model of the battery is verified by estimating a temperature of a surface of the battery. Therefore, convenience is brought for state calculation and fault diagnosis of a BMS, which facilitates implementation of a function of a thermal management system for the battery, thereby improving reliability and safety of a battery pack.

2. The thermal model provided in the present disclosure can greatly reduce an amount of calculation while accuracy of the model is guaranteed, and is suitable for batteries of any shapes.

### BRIEF DESCRIPTION OF THE DRAWINGS

To describe the technical solutions in the embodiments of the present disclosure or in the prior art more clearly, the accompanying drawings required for the embodiments are briefly described below. Apparently, the accompanying drawings in the following descriptions show merely some embodiments of the present disclosure, and those of ordinary skill in the art may still derive other accompanying drawings from these accompanying drawings without creative efforts.

FIG. 1 is a flowchart of building and verifying a thermal model according to an embodiment of the present disclosure;

FIG. 2 is a flowchart of details according to an embodiment of the present disclosure;

FIG. 3 is a schematic diagram of a building process of a thermal model an embodiment of the present disclosure; and

FIG. 4 is a layered diagram of an internal structural of a cylindrical power lithium-ion battery according to an embodiment of the present disclosure.

### DETAILED DESCRIPTION OF THE EMBODIMENTS

The technical solutions of the embodiments of the present disclosure are clearly and completely described below with reference to the accompanying drawings in the embodiments of the present disclosure. Apparently, the described embodiments are merely some rather than all of the embodiments of the present disclosure. All other embodiments acquired by those of ordinary skill in the art based on the embodiments of the present disclosure without creative efforts shall fall within the protection scope of the present disclosure.

The present disclosure provides a method and system for building a thermal model of a power lithium-ion battery based on an electrochemical mechanism, to verify accuracy of a heat generation model of a battery by estimating a temperature of a surface of the battery, thereby improving reliability and safety of a battery pack.

To make the above-mentioned objective, features, and advantages of the present disclosure clearer and more comprehensible, the present disclosure will be further described in detail below with reference to the accompanying drawings and specific embodiments.

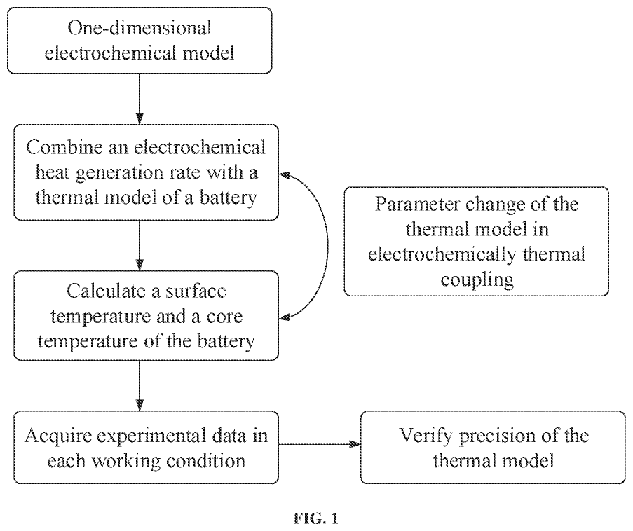

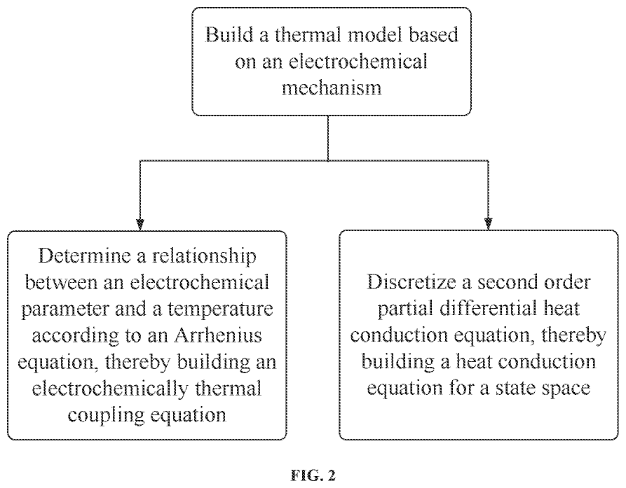

An embodiment of the present disclosure provides a method for building a thermal model of a power lithium-ion battery based on an electrochemical mechanism. Referring to FIG. 1 and FIG. 2, the method specifically includes the following steps.

Step S1: Discretize a second order partial differential heat conduction equation of a power lithium-ion battery according to a finite differential method, thereby building a thermal model of the power lithium-ion battery. Step S1 specifically includes the following steps.

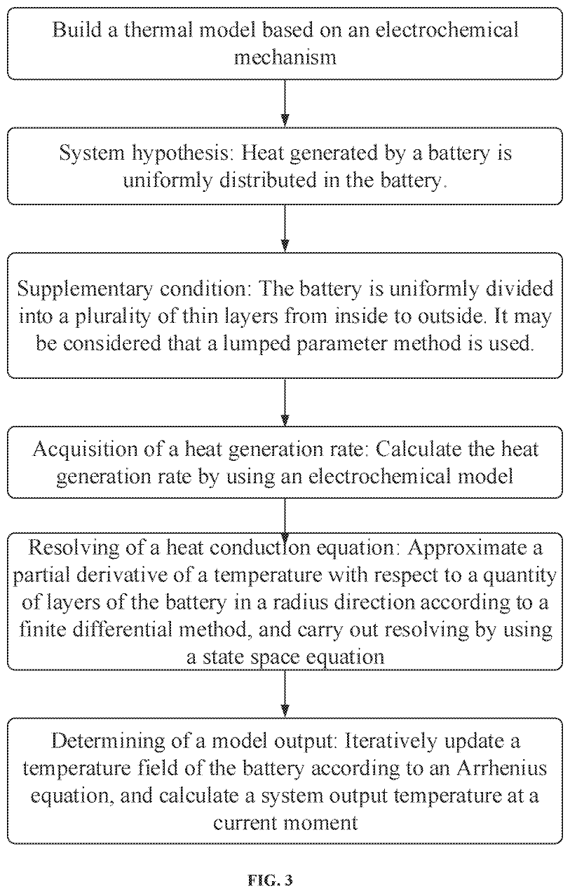

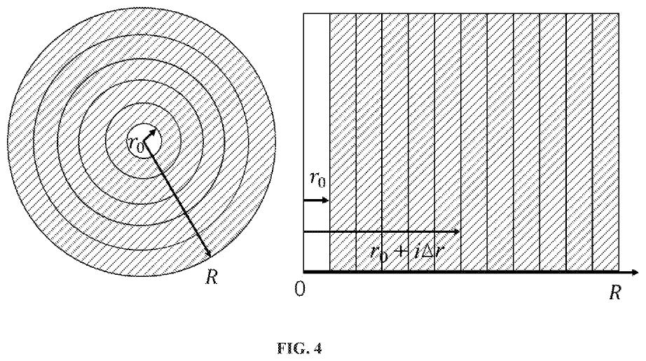

Discretize a second order partial differential import equation of a cylindrical power lithium-ion battery according to the finite differential method, thereby building a thermal model of a one-dimensional state space of the cylindrical power lithium-ion battery. For details, referring to FIG. 3 and FIG. 4. A left diagram in FIG. 4 is a top view of an internal structural of a cylindrical power lithium-ion battery; and a right diagram in FIG. 4 is a front view of the internal structural of the cylindrical power lithium-ion battery.

Assume that a temperature distribution of the cylindrical power lithium-ion battery complies with the following one-dimensional unsteady-state heat conduction equation of cylindrical coordinates:

$$ρ c \frac{\partial T}{\partial t} = \frac{λ}{r} \frac{\partial T}{\partial r} + λ \frac{{\partial }^{2} T}{\partial {r}^{2}} + q , namely , ρ c \frac{\partial T}{\partial t} = \frac{λ}{r} \frac{\partial T}{\partial r} + \frac{{\partial }^{2} T}{{\partial }^{2} r} + q ( t ) .$$

T denotes a temperature of the battery; t denotes a current moment; r denotes an electrode radius of a layer; q denotes a heat generation rate per unit volume; and q(t) denotes a heat generation rate per unit volume at the current moment.

Build a boundary condition:

$$\{ \begin{matrix}- λ \frac{\partial T}{\partial r} {\vert}_{{r}_{0}} = {h}_{0} ( {T}_{0} - {T}_{1} ) = 0 \\ - λ \frac{\partial T}{\partial r} {\vert}_{R} = h ( {T}_{R} - {T}_{amb} )\end{matrix} .$$

r₀ denotes a radius of a hollow portion of the battery; R denotes a diameter of the surface of the battery; and T_{amb} denotes an ambient temperature.

Build an initial condition: T(t)=T_{amb}.

Build a supplementary condition: T₁(t)≈T₀(t).

T₀ denotes a temperature of a thin air layer that is of a hollow portion of the battery and that is closest to an inner-most layer of the battery; T₁ and T_{R} respectively denote a temperature of the inner-most layer of the battery and a temperature of a surface of the battery; h₀ and h respectively denote a convection-diffusion coefficient of the thin air layer and that of the surface of the battery;

$$a = \frac{λ}{ρ c}$$

denotes a thermal diffusivity; ρ denotes a density of the power lithium-ion battery; c denotes a specific heat capacity J/(kg·° C.) of the power lithium-ion battery; and λ denotes a radial thermal conductivity.

Respectively approximate a first-order partial differential equation and a second-order partial differential equation by using a backward difference method and a central difference method, thereby discretizing the second order partial differential heat conduction equation:

$$\frac{\partial T}{\partial r} \approx \frac{{T}_{k + 1} - {T}_{k - 1}}{2 Δ r} , \frac{{\partial }^{2} r}{\partial {r}^{2}} \approx \frac{{T}_{k + 1} - 2 {T}_{k} + {T}_{k - 1}}{{( Δ r )}^{2}} .$$

Represent the one-dimensional unsteady-state heat conduction equation of the cylindrical power lithium-ion battery as follows:

$${\dot{T}}_{k} = \frac{{a}_{k}}{{r}_{k}} \frac{{T}_{k + 1} - {T}_{k - 1}}{2 Δ r} + {a}_{k} \frac{{T}_{k + 1} - 2 {T}_{k} + {T}_{k - 1}}{{( Δ r )}^{2}} + \frac{{a}_{k}}{λ} q ( t ) , \\ k = 1 , 2 , 3 … , M - 1. \\ Δ r = \frac{R - {r}_{0}}{M} ; {r}_{k} = {r}_{0} + k Δ r ;$$

M denotes a quantity of walls of the cylindrical power lithium-ion battery; and r_{M}=R.

When

$${b}_{k} = \frac{{a}_{k}}{2 {r}_{k} Δ r} and {d}_{k} = \frac{2 {a}_{k}}{{( Δ r )}^{2}} ,$$

$${\dot{T}}_{k} = ( {b}_{k} + {d}_{k} ) {T}_{k + 1} - 2 {d}_{k} {T}_{k} + ( - {b}_{k} + {d}_{k} ) {T}_{k - 1} + \frac{{a}_{k}}{λ} q ( t ) .$$

Represent the temperature T_{M} of the surface of the battery as follows:

$${T}_{k = M} = \frac{{λ}_{M}}{h Δ {r}_{M} + {λ}_{M}} {T}_{k = M - 1} + \frac{h Δ {r}_{M}}{h Δ {r}_{M} + {λ}_{M}} {T}_{amb} .$$

q(t)=qₚ+qᵣ; the equation is solved in step S1.1.4; T_{M}=T_{R}; T_{M} denotes a temperature of an outer layer of the battery; λ_{M} denotes a thermal conductivity of an outer-layer material; and Δr_{M} denotes a thickness of the outer-layer material.

According to a polarization phenomenon and a current heating effect in charging and discharging processes of the battery, build the following calculation formula for a heat release rate of polarization heat and ohmic heat in a use process of the battery:

qₚ=I²R_{act}+I²Rₒₕₘ=I²Rₜ.

I denotes a current of the battery; R_{act} denotes a polarization internal resistance of the battery; Rₒₕₘ denotes an ohmic internal resistance of the battery; Rₜ denotes a total internal resistance of the battery; and qₚ denotes a heat release rate of polarization heat and ohmic heat in a discharging process of the battery.

Combine calculation steps to acquire the following total heating power:

q=qᵣ+qₚ.

q denotes a total heating power; qᵣ denotes a heat release rate of reaction heat of the battery; and qₚ denotes the heat release rate of the polarization heat and ohmic heat in the discharging process of the battery.

Determine a final model output according to an actual design demand for a system; carry out approximation according to the finite differential method; iteratively update an electrochemical parameter of the battery according to an Arrhenius equation; and calculate a system output temperature at a current moment.

Define a system state equation: \dot{x}=Ax+Bu.

Define a system output equation: y=Cx+Du.

u denotes a system input; both C and D denote system matrices; a₁ denotes a coefficient of a thermal diffusivity of a first inner layer of the cylinder; λ₁ denotes a thermal conductivity of the first inner layer of the cylinder; and T denotes a temperature of the battery.

A and B denote system matrices; a system state is denoted by x=(T₁, T₂, . . . , Tᵢ, . . . , T_{M-1})^{T}; a system input is denoted by q and is a heat generation rate per unit volume; and system output y denotes a temperature of an (M−1)^{th} layer of the battery.

Specifically, each system matrix is denoted as follows:

$$A = ( - ( {b}_{1} + {d}_{1} ) , ( {b}_{1} + {d}_{1} ) , 0 , … , 0 ; \\ - ( {b}_{2} + {d}_{2} ) , - 2 {d}_{2} , ( {b}_{2} + {d}_{2} ) , … , 0 ; … ; 0 , 0 , 0 , \\ … , - ( {b}_{M - 1} + {d}_{M - 1} ) , ( \frac{{λ}_{M - 1} ( {b}_{M - 1} + {d}_{M - 1} )}{h Δ r + {λ}_{M - 1}} - 2 {d}_{M - 1} ) ) ; \\ B ( i , 1 ) = {ρ}_{i} {c}_{i} ; \\ C = {( 0 , 0 , … , 0 , 1 )}^{T} ; \\ and D = 0.$$

[symbol]

denotes an axial thermal conductivity of an (M−1)^{th} layer; |B(i,1) denotes a system matrix expression of an i^{th} layer; i denotes an expression of a layer number; ρᵢ denotes a density of a battery material of the i^{th} layer; cᵢ| denotes a battery specific heat capacity of the i^{th} layer; and a temperature denoted by system output y may be determined by adjusting a location of 1 in matrix C.

Secondly, an impact of a temperature on an electrochemical parameter of the battery is determined according to an Arrhenius equation, thereby establishing a coupling relationship of the temperature to the electrochemical parameter of the battery.

An impact of a temperature on a parameter of the battery is determined based on the relationship between a temperature and an electrochemical parameter of the battery according to the following Arrhenius equation:

$$ψ = {ψ}_{ref} exp [ \frac{{E}_{a}^{ψ}}{R} ( \frac{1}{{T}_{ref}} - \frac{1}{T} ) ] .$$

ψ_{ref} is a general variable denoting a diffusion coefficient of a substance, an electrical conductivity of an electrolyte, an exchange current density of an electrode reaction electrode reaction, or the like; subscript ref denotes a value at a reference temperature; E_{Ω}^{ψ} denotes an activation energy; ψ denotes a diffusion coefficient; and T_{ref} denotes a reference temperature.

The thermal model of the one-dimensional state space of the cylindrical power lithium-ion battery is built based on finite difference and discretization.

Step S2: Carry out a dynamic working condition test by using a cylindrical power lithium-ion battery selected as an object, thereby acquiring experimental data such as a temperature, a current, a voltage, and a temperature of a surface of the battery. Step S2 specifically includes the following steps:

step S2.1: selecting a power lithium-ion battery to be tested; and adhering thermocouples to the power lithium-ion battery according to a layout solution;

step S2.2: allowing the battery to stand still in a 25° C. incubator for 2 h;

step S2.3: charging the battery in a constant-current and constant-voltage manner to a fully charged state, namely, SOC=100%; discharging the battery at a speed of C/3 to SOC=95%; and allowing the battery to stand still for 2 h;

step S2.4: loading a dynamic working condition (UDDS) to the battery by an appropriate proportion till SOC of the battery decreases to about 5%;

step S2.5: recording data such as a current, a voltage, an ambient temperature, and a surface temperature in the working condition;

step S2.6: repeating steps S2.2 to S2.5 at the same ambient temperature; and acquiring test data at the temperature in dynamic working conditions such as FUDS and UDDS; and

step S2.7: changing the temperature of the incubator to 5° C., 10° C., and 35° C.; repeating steps S2.2 to S2.6; and acquiring test data at 5° C., 10° C. and 35° C. in the dynamic working conditions.

Step S3: Identify an electrochemical parameter of the power lithium-ion battery according to an optimal parameter algorithm by using test data acquired in a dynamic working condition, thereby building a thermal model of the power lithium-ion battery, where the optimal parameter algorithm in step S3 is a least square method. This step is not limited to the optimal parameter algorithm.

Step S4: Verify accuracy of the thermal model of the power lithium-ion battery by using test data acquired in another dynamic working condition.

In practical application, the temperature of each layer of a specific power lithium-ion battery can be obtained by using the verified thermal model of the power lithium-ion battery. It is determined whether the power lithium-ion battery operates in a safety state by comparing the obtained temperature with a predetermined threshold. If the power lithium-ion battery does not operate in the safety state, a warning such as audio and text warnings is issued, to instruct the user to turn off a switch of the power lithium-ion battery. Alternatively, a controlling signal can be sent to a switching control circuit of the power lithium-ion battery, which can turn off the power lithium-ion battery in response to the controlling signal.

The thermal model of the power lithium-ion battery according to embodiments of the present disclosure can be carried on hardware devices such as computers or embedded in Battery Management System (BMS) for implementation. BMS is an important component for connecting on-board battery and battery electric vehicle. Functions of the BMS can include: voltage collection of a battery, temperature collection of a battery, current detection of a battery pack, SOC measurement of a battery/a battery pack, assessment of state of health (SOH) of a battery pack, insulation detection and leakage protection, thermal management control and communication, key data recording, fault analysis on a battery and online alarm, etc. When the thermal model of the power lithium-ion battery is embedded in the BMS, the BMS acquires the temperature of each layer of the power lithium-ion battery in real time, and determine whether the power lithium-ion battery operates in a safety state by comparing the key data with the predetermined threshold. If the power lithium-ion battery does not operate in the safety state, an audible alarm can be alarmed, or a text prompt can be displayed on a display, to instruct the user to perform relevant operations or turn off the switch of the power lithium-ion battery.

In conclusion, an embodiment of the present disclosure provides a method for building a thermal model of a power lithium-ion battery based on an electrochemical mechanism. According to this method, a heat generation rate of a battery is acquired by analyzing an electrochemical mechanism of the battery; and accuracy of a heat generation model of the battery is verified by estimating a temperature of a surface of the battery. Therefore, convenience is brought for state calculation and fault diagnosis of a BMS, which facilitates implementation of a function of a thermal management system for the battery, thereby improving reliability and safety of a battery pack.

Those skilled in the art are aware that in addition to being realized by using pure computer-readable program code, the system and each apparatus, module, and unit thereof provided in the present disclosure can realize a same program in a form of a logic gate, a switch, an application-specific integrated circuit, a programmable logic controller, or an embedded microcontroller by performing logic programming on the method steps. Therefore, the system and each apparatus, module, and unit thereof provided in the present disclosure can be regarded as a kind of hardware component. The apparatus, module, and unit included therein for realizing each function can also be regarded as a structure in the hardware component; and the apparatus, module, and unit for realizing each function can also be regarded as a software module for implementing the method or a structure in the hardware component.

The specific embodiments of the present disclosure are described above. It should be understood that the present disclosure is not limited to the above specific implementations, and a person skilled in the art can make various variations or modifications within the scope of the claims without affecting the essence of the present disclosure. The embodiments in the present disclosure and features in the embodiments may be freely combined with each other in a non-conflicting manner.

Each embodiment of the present specification is described in a progressive manner, each embodiment focuses on the difference from other embodiments, and the same and similar parts between the examples may refer to each other.

In this specification, some specific embodiments are used for illustration of the principles and implementations of the present disclosure. The description of the foregoing embodiments is used to help illustrate the method of the present disclosure and the core ideas thereof. In addition, those of ordinary skill in the art can make various modifications in terms of specific implementations and the scope of application in accordance with the ideas of the present disclosure. In conclusion, the content of the present description shall not be construed as limitations to the present disclosure.

What is claimed is:

1. A method for building a thermal model of a power lithium-ion battery based on an electrochemical mechanism, comprising:
step S1: discretizing a second order partial differential heat conduction equation of a power lithium-ion battery according to a finite differential method, thereby building a thermal model of the power lithium-ion battery;
step S2: carrying out a dynamic working condition test by using a cylindrical power lithium-ion battery selected as an object, thereby acquiring test data such as a temperature, a current, a voltage, and a temperature of a surface of the battery;
step S3: identifying an electrochemical parameter of the power lithium-ion battery according to an optimal parameter algorithm by using test data acquired in a dynamic working condition, thereby building a thermal model of the power lithium-ion battery; and
step S4: verifying accuracy of the thermal model of the power lithium-ion battery by using test data acquired in another dynamic working condition;
step S5: acquiring a temperature of a specific power lithium-ion battery by using a verified thermal model of the power lithium-ion battery, comparing the acquired temperature with a predetermined threshold, and controlling a switch of the specific power lithium-ion battery to turn off according to a comparison result.

2. The method according to claim 1, wherein step S1 comprises:
step S1.1: discretizing a second order partial differential import equation of a cylindrical power lithium-ion battery according to the finite differential method, thereby building a thermal model of a one-dimensional state space of the cylindrical power lithium-ion battery; and
step S1.2: determining an impact of a temperature on an electrochemical parameter of the battery according to an Arrhenius equation, thereby establishing a coupling relationship of the temperature to the electrochemical parameter of the battery.

3. The method according to claim 2, wherein step S1.1 specifically comprises:
step S1.1.1: assuming that a temperature distribution of the cylindrical power lithium-ion battery complies with the following one-dimensional unsteady-state heat conduction equation of cylindrical coordinates:
$$ρ c \frac{\partial T}{\partial t} = \frac{λ}{r} \frac{\partial T}{\partial r} + λ \frac{{\partial }^{2} T}{\partial {r}^{2}} + q ;$$
building a boundary condition:
$$\{ \begin{matrix}{- λ \frac{\partial T}{\partial r} \vert}_{{r}_{0}} = {h}_{0} ( {T}_{0} - {T}_{1} ) = 0 \\ {- λ \frac{\partial T}{\partial r} \vert}_{R} = h ( {T}_{R} - {T}_{amb} )\end{matrix} ;$$
building an initial condition: T(t)=T_{amb}; and
building a supplementary condition: T₁(t)≈T₀(t),
wherein T₀ denotes a temperature of a thin air layer that is of a hollow portion of the battery and that is closest to an inner-most layer of the battery; T₁ denotes a temperature of the inner-most layer of the battery; T_{R} denotes a temperature of a surface of the battery; h₀ denotes a convection-diffusion coefficient of the thin air layer; h denotes a convection-diffusion coefficient of the surface of the battery;
$$a = \frac{λ}{ρ c}$$
denotes a thermal diffusivity; ρ denotes a density of the power lithium-ion battery; c denotes a specific heat capacity J/(kg·° C.) of the power lithium-ion battery; and λ denotes a radial thermal conductivity;
step S1.1.2: respectively approximating a first-order partial differential equation and a second-order partial differential equation by using a backward difference method and a central difference method, thereby discretizing the second order partial differential heat conduction equation:
$$\frac{\partial T}{\partial r} \approx \frac{{T}_{k + 1} - {T}_{k - 1}}{2 Δ r} , \frac{{\partial }^{2} T}{\partial {r}^{2}} \approx \frac{{T}_{k + 1} - 2 {T}_{k} + {T}_{k - 1}}{{( Δ r )}^{2}} ;$$
step S1.1.3: representing the one-dimensional unsteady-state heat conduction equation of the cylindrical power lithium-ion battery as follows:
$${\dot{T}}_{k} = \frac{{a}_{k}}{{r}_{k}} \frac{{T}_{k + 1} - {T}_{k - 1}}{2 Δ r} + {a}_{k} \frac{{T}_{k + 1} - 2 {T}_{k} + {T}_{k - 1}}{{( Δ r )}^{2}} + \frac{{a}_{k}}{λ} q ( t ) , \\ k = 1 , 2 , 3 … , M - 1 ,$$
wherein
$$Δ r = \frac{R - {r}_{0}}{M} ; {r}_{k} = {r}_{0} + k Δ r ;$$
M denotes a quantity of walls of the cylindrical power lithium-ion battery; and r_{M}=R; and
when
$${b}_{k} = \frac{{a}_{k}}{2 {r}_{k} Δ r} and {d}_{k} = \frac{2 {a}_{k}}{{( Δ r )}^{2}} ,$$
$${\dot{T}}_{k} = ( {b}_{k} + {d}_{k} ) {T}_{k + 1} - 2 {d}_{k} {T}_{k} + ( - {b}_{k} + {d}_{k} ) {T}_{k - 1} + \frac{{a}_{k}}{λ} q ( t ) ;$$
and
representing the temperature T_{M} of the surface of the battery as follows:
$${T}_{k = M} = \frac{{λ}_{M}}{h Δ {r}_{M} + {λ}_{M}} {T}_{k = M - 1} + \frac{h Δ {r}_{M}}{h Δ {r}_{M} + {λ}_{M}} {T}_{amb} ,$$
wherein q(t)=qₚ+qᵣ; the equation is solved in step S1.1.4; T_{M}=T_{R}; T_{M} denotes a temperature of an outer layer of the battery; λ_{M} denotes a thermal conductivity of an outer-layer material; λr_{M} denotes a thickness of the outer-layer material; and q(t) denotes a heating power of the battery at moment t;
step S1.1.4: according to a polarization phenomenon and a current heating effect in charging and discharging processes of the battery, building the following calculation formula for a heat release rate of polarization heat and ohmic heat in a use process of the battery:
qₚ=I²R_{act}+I²Rₒₕₘ=I²Rₜ,
wherein I denotes a current of the battery; R_{act} denotes a polarization internal resistance of the battery; Rₒₕₘ denotes an ohmic internal resistance of the battery; Rₜ denotes a total internal resistance of the battery; and qₚ denotes a heat release rate of polarization heat and ohmic heat in a discharging process of the battery; and
combining calculation steps to acquire the following total heating power:
q=qᵣ+qₚ,
wherein q denotes a total heating power; qᵣ denotes a heat release rate of reaction heat of the battery; and qₚ denotes the heat release rate of the polarization heat and ohmic heat in the discharging process of the battery; and
step S1.1.5: determining a final model output according to an actual design demand for a system; carrying out approximation according to the finite differential method; iteratively updating an electrochemical parameter of the battery according to an Arrhenius equation; and calculating a system output temperature at a current moment;
defining a system state equation: \dot{x}=Ax+Bu; and
defining a system output equation: y=Cx+Du,
wherein A and B denote system matrices: a system state is denoted by x=(T₁, T₂, . . . , Tᵢ, . . . , T_{M-1})^{T}; a system input is denoted by q; and system output y denotes a temperature of an (M−1)^{th} layer of the battery.

4. The method according to claim 2, wherein step S1.2 specifically comprises: based on the relationship between a temperature and an electrochemical parameter of the battery, determining an impact of a temperature on a parameter of the battery according to the following Arrhenius equation:
$$ψ = {ψ}_{ref} exp [ \frac{{E}_{a}^{ψ}}{R} ( \frac{1}{{T}_{ref}} - \frac{1}{T} ) ] ,$$
wherein ψ_{ref} is a general variable denoting a diffusion coefficient of a substance, an electrical conductivity of an electrolyte, an exchange current density of an electrode reaction electrode reaction, or the like; subscript ref denotes a value at a reference temperature; and Eₐ^{ψ} denotes an activation energy.

5. The method according to claim 3, wherein in the step S1.1.5, each system matrix is denoted as follows:
$$A = ( - ( {b}_{1} + {d}_{1} ) , ( {b}_{1} + {d}_{1} ) , 0 , … , 0 ; - ( {b}_{2} + {d}_{2} ) , - 2 {d}_{2} , ( {b}_{2} + {d}_{2} ) , … , \\ 0 : … ; 0 , 0 , 0 , … , - ( {b}_{M - 1} + {d}_{M - 1} ) , ( \frac{{λ}_{M - 1} ( {b}_{M - 1} + {d}_{M - 1} )}{h Δ r + {λ}_{M - 1}} - 2 {d}_{M - 1} ) )$$
$$B ( i , 1 ) = {ρ}_{i} {c}_{i} ;$$
$$C = {( 0 , 0 , … , 0 , 1 )}^{1} ; and$$
$$D = 0 ,$$
wherein a temperature denoted by system output y may be determined by adjusting a location of 1 in matrix C.

6. The method according to claim 1, wherein step S2 comprises:
step S2.1: selecting a power lithium-ion battery to be tested; and adhering thermocouples to the power lithium-ion battery according to a layout solution;
step S2.2: allowing the battery to stand still in a 25° C. incubator for 2 h;
step S2.3: charging the battery in a constant-current and constant-voltage manner to a fully charged state, namely, SOC=100%; discharging the battery at a speed of C/3 to SOC=95%; and allowing the battery to stand still for 2 h;
step S2.4: loading a dynamic working condition (UDDS) to the battery by an appropriate proportion till SOC of the battery decreases to about 5%;
step S2.5: recording data such as a current, a voltage, an ambient temperature, and a surface temperature in the working condition;
step S2.6: repeating steps S2.2 to S2.5 at the same ambient temperature; and acquiring test data at the temperature in dynamic working conditions such as FUDS and UDDS; and
step S2.7: changing the temperature of the incubator to 5° C., 10° C., and 35° C.; repeating steps S2.2 to 52.6; and acquiring test data at each of the temperatures in the dynamic working conditions.

7. The method according to claim 1, wherein the optimal parameter algorithm in step S3 is a least square method.

8. A system for building a thermal model of a power lithium-ion battery based on an electrochemical mechanism, comprising:
module M1 configured to: discretize a second order partial differential heat conduction equation of a power lithium-ion battery according to a finite differential method, thereby building a thermal model of the power lithium-ion battery;
a module M2 configured to: carry out a dynamic working condition test by using a cylindrical power lithium-ion battery selected as an object, thereby acquiring test data such as a temperature, a current, a voltage, and a temperature of a surface of the battery;
a module M3 configured to: identify an electrochemical parameter of the power lithium-ion battery according to an optimal parameter algorithm by using test data acquired in a dynamic working condition, thereby building a thermal model of the power lithium-ion battery; and
a module M4 configured to: verify accuracy of the thermal model of the power lithium-ion battery by using test data acquired in another dynamic working condition, acquire a temperature of a specific power lithium-ion battery by using a verified thermal model of the power lithium-ion battery, compare the acquired temperature with a predetermined threshold, and control a switch of the specific power lithium-ion battery to turn off, according to a comparison result.

9. The system according to claim 8, wherein the module M1 comprises:
a module M1.1 configured to: discretize a second order partial differential import equation of a cylindrical power lithium-ion battery according to the finite differential method, thereby building a thermal model of a one-dimensional state space of the cylindrical power lithium-ion battery, and
a module M1.2 configured to: determine an impact of a temperature on an electrochemical parameter of the battery according to an Arrhenius equation, thereby establishing a coupling relationship of the temperature to the electrochemical parameter of the battery.

10. The system according to claim 9, wherein the module M1.1 specifically comprises:
a module M1.1.1 configured to: assume that a temperature distribution of the cylindrical power lithium-ion battery complies with the following one-dimensional unsteady-state heat conduction equation of cylindrical coordinates:
$$ρ c \frac{\partial T}{\partial t} = \frac{λ}{r} \frac{\partial T}{\partial r} + λ \frac{{\partial }^{2} T}{\partial {r}^{2}} + q ;$$
building a boundary condition:
$$\{ \begin{matrix}{- λ \frac{\partial T}{\partial r} \vert}_{{r}_{0}} = {h}_{0} ( {T}_{0} - {T}_{1} ) = 0 \\ {- λ \frac{\partial T}{\partial r} \vert}_{R} = h ( {T}_{R} - {T}_{amb} )\end{matrix} ;$$
building an initial condition: T(t)=T_{amb}; and
building a supplementary condition: T₁(t)≈T₀(t),
wherein T₀ denotes a temperature of a thin air layer that is of a hollow portion of the battery and that is closest to an inner-most layer of the battery; T₁ and T_{R} respectively denote a temperature of the inner-most layer of the battery and a temperature of a surface of the battery; h₀ and h respectively denote a convection-diffusion coefficient of the thin air layer and that of the surface of the battery;
$$a = \frac{λ}{ρ c}$$
denotes a thermal diffusivity; ρ denotes a density of the power lithium-ion battery; c denotes a specific heat capacity J/(kg·° C.) of the power lithium-ion battery; and λ denotes a radial thermal conductivity;
a module M1.1.2 configured to: respectively approximate a first-order partial differential equation and a second-order partial differential equation by using a backward difference method and a central difference method, thereby discretizing the second order partial differential heat conduction equation:
$$\frac{\partial T}{\partial r} \approx \frac{{T}_{k + 1} - {T}_{k - 1}}{2 Δ r} , \frac{{\partial }^{2} T}{\partial {r}^{2}} \approx \frac{{T}_{k + 1} - 2 {T}_{k} + {T}_{k - 1}}{{( Δ r )}^{2}} ;$$
module M1.1.3 configured to: represent the one-dimensional unsteady-state heat conduction equation of the cylindrical power lithium-ion battery as follows:
$${\dot{T}}_{k} = \frac{{a}_{k}}{{r}_{k}} \frac{{T}_{k + 1} - {T}_{k - 1}}{2 Δ r} + {a}_{k} \frac{{T}_{k + 1} - 2 {T}_{k} + {T}_{k - 1}}{{( Δ r )}^{2}} + \frac{{a}_{k}}{λ} q ( t ) , \\ k = 1 , 2 , 3 … , M - 1 ,$$
wherein
$$Δ r = \frac{R - {r}_{0}}{M} ; {r}_{k} = {r}_{0} + k Δ r ;$$
M denotes a quantity of walls of the cylindrical power lithium-ion battery; and r_{M}=R; and
when
$${b}_{k} = \frac{{a}_{k}}{2 {r}_{k} Δ r} and {d}_{k} = \frac{2 {a}_{k}}{{( Δ r )}^{2}} ,$$
$${\dot{T}}_{k} = ( {b}_{k} + {d}_{k} ) {T}_{k + 1} - 2 {d}_{k} {T}_{k} + ( - {b}_{k} + {d}_{k} ) {T}_{k - 1} + \frac{{a}_{k}}{λ} q ( t ) ;$$
and
represent the temperature T_{M} of the surface of the battery as follows:
$${T}_{k = M} = \frac{{λ}_{M}}{h Δ {r}_{M} + {λ}_{M}} {T}_{k = M - 1} + \frac{h Δ {r}_{M}}{h Δ {r}_{M} + {λ}_{M}} {T}_{amb} ,$$
wherein q(t)=qₚ+qᵣ; the equation is solved by using module M1.1.4; T_{M}=T_{R}; T_{M} denotes a temperature of an outer layer of the battery; λ_{M} denotes a thermal conductivity of an outer-layer material; and Arm denotes a thickness of the outer-layer material;
a module M1.1.4 configured to: according to a polarization phenomenon and a current heating effect in charging and discharging processes of the battery, build the following calculation formula for a heat release rate of polarization heat and ohmic heat in a use process of the battery:
qₚ=I²R_{act}+I²Rₒₕₘ=I²Rₜ,
wherein I denotes a current of the battery; R_{act} denotes a polarization internal resistance of the battery; Rₒₕₘ denotes an ohmic internal resistance of the battery; Rₜ denotes a total internal resistance of the battery; and qₚ denotes a heat release rate of polarization heat and ohmic heat in a discharging process of the battery; and
combine calculation steps to acquire the following total heating power:
q=qᵣ+qₚ,
wherein q denotes a total heating power; qᵣ denotes a heat release rate of reaction heat of the battery; and qₚ denotes the heat release rate of the polarization heat and ohmic heat in the discharging process of the battery; and
a module M1.1.5 configured to: determine a final model output according to an actual design demand for a system; carry out approximation according to the finite differential method; iteratively update an electrochemical parameter of the battery according to an Arrhenius equation; and calculate a system output temperature at a current moment;
define a system state equation: \dot{x}=AX+Bu; and
define a system output equation: y=Cx+Du,
wherein A and B denote system matrices; a system state is denoted by x=(T₁, T₂, . . . , Tᵢ, . . . , T_{M-1})^{T}; a system input is denoted by q and is a heat generation rate per unit volume; and system output y denotes a temperature of an (M−1)^{th} layer of the battery.
